(19) United States
(12) Patent Application Publication
(10) Pub. No.: US 2026/0077465 A1
(43) Pub. Date: Mar. 19, 2026

(54) STAPLER DEVICE WITH ANTI-JAMMING MAGAZINE

(71) Applicant: FASCO S.R.L., Castel Maggiore (IT)

(72) Inventor: Andrea Carati, GRANAROLO DELL'EMILIA (IT)

(21) Appl. No.: 19/486,493

(22) PCT Filed: May 22, 2024
(86) PCT No.: PCT/EP2024/064116

§ 371 Date: Nov. 21, 2025

(30) Foreign Application Priority Data
May 25, 2023 (IT) 102023000010620

(51) Int. Cl. B25C 5/16

(52) U.S. Cl. CPC B25C 5/1617; B25C 5/1696

(57) ABSTRACT

Stapler device with anti-jamming magazine of the staples (S) and provided with a strike site (F) of the staples fed by the magazine (1) comprising at least:—a container element (3) for storing and sliding the staples (S) towards the strike site (F);—a closure member (5) of the container (3) to open and close the latter;—a thrusting member (7), having two mutually parallel sidewalls and a connection wall approximately perpendicular to the sidewalls and of which it connects two sides so that at least one cross section of this thrusting member is U-shaped; said thrusting member (7) is assigned to transmit to the staples (S) contained in the container element (3) of the magazine (1) an elastic force directed towards the strike site. Said device comprises a support member (9) assigned to support the thrusting member (7) and to slide along at least one first guide member (13) of the stapler device, and it comprises resilient means (17) acting, in the direction of the strike site, on the thrusting member (7) directly or by means of the support member (9), which is provided with at least a concave housing (19) for matching with outer faces of free edges (21), opposite to the respective connecting sides of the transverse connection wall, of the side walls of the thrusting member (7) preventing deformation of the latter (7).

### TECHNICAL FIELD

The present invention relates to the technical field concerning devices for applying staples and refers to a stapler device with anti-jamming magazine of the staples.

### PRIOR ART

Manual devices are known, generally pneumatically operated, assigned for applying staples, typically made of metal and in the shape of a squared “U”, and which are held to fix sheets, fabrics, coverings, perforable materials, such as wood, and other materials, to supports or elements generally made of wood, its derivatives or made of synthetic materials, such as plastic.

These known devices are provided with a head capable of quickly accelerating a driving plunger which, following the firing command given by means of a trigger, acts on the staple fed and positioned in a strike site from a magazine, ejecting or firing that staple from said site from the device with such speed and force as to push it into the elements to be fixed mutually.

The staples are mutually joined, in a weak way, to form an array of aligned staples, forming a strip of staples that are easily separable from each other.

The magazine comprises a container for storing and sliding the strip of staples and a pusher which acts elastically on the end of the strip of staples opposite the strike position in the direction of that position.

The pusher generally has a “U” section which approximately reproduces the shape and size of the staples.

A disadvantage of these known devices consists in the fact that the pusher, following repeated stresses, can be subject to deformations which tend to spread the arms apart which therefore lose their original parallelism with consequent risk of friction and jamming of the pusher itself.

Another disadvantage of these known devices consists in the fact that the pusher can transmit the elastic force to the strip of staples in an insufficiently balanced and regular way, causing the risk of the staples sticking, jamming or getting stuck in the container or against the pusher itself.

Another disadvantage consists in the fact that sometimes the pusher can exert excessive pressure against the staples, deforming them or causing them to be deformed by the driving plunger with the risk of jamming or incorrect fixing.

### DISCLOSURE OF THE INVENTION

An object of the present invention is to propose a stapler device with anti-jamming magazine of the staples, virtually free from the risk of jamming of the pusher.

Another object is to propose a device that does not cause jamming or deformations to the staples.

A further object is to propose a device provided with a relatively simple, economical, robust and reliable magazine.

### BRIEF DESCRIPTION OF THE DRAWINGS

The characteristics of the invention are highlighted below with particular reference to the attached drawings in which:

FIG. 1 illustrates a side view of the stapler device with anti-jamming magazine object of the present invention;

FIG. 2 illustrates a sectional view according to plane II-II of FIG. 1;

FIG. 3 illustrates an axonometric view and from below of the device of FIG. 1 containing staples and in a partially open condition;

FIG. 4 illustrates an enlarged detail of FIG. 3;

FIG. 5 illustrates a bottom view of the device of FIG. 1;

FIG. 6 illustrates a sectional view according to plane VI-VI of FIG. 5;

FIG. 7 illustrates an axonometric view of a closure member of FIG. 1;

FIG. 8 illustrates an axonometric and exploded view of a container element of FIG. 1;

FIG. 9 illustrates an axonometric and exploded view of the closure member of FIGS. 1 and 7;

FIG. 10 illustrates an axonometric view of some parts of FIG. 9 in a condition corresponding to that of the device assembly;

FIG. 11 illustrates an axonometric and enlarged view of two elements of FIG. 9;

FIG. 12 illustrates an axonometric view and from a different point of view of one of the elements of FIG. 11;

FIG. 13 shows a front view of the element of FIG. 12;

FIG. 14 illustrates a sectional view according to the plane XIII-XIII of FIG. 13;

FIGS. 15 and 16 illustrate the element of FIG. 13 from other points of view.

### BEST MODE TO CARRY OUT THE INVENTION

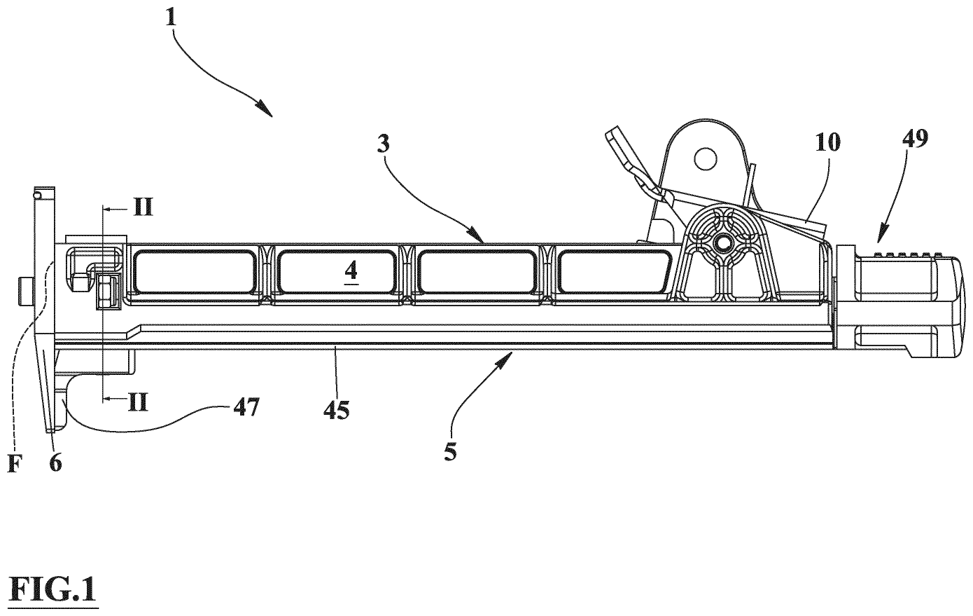

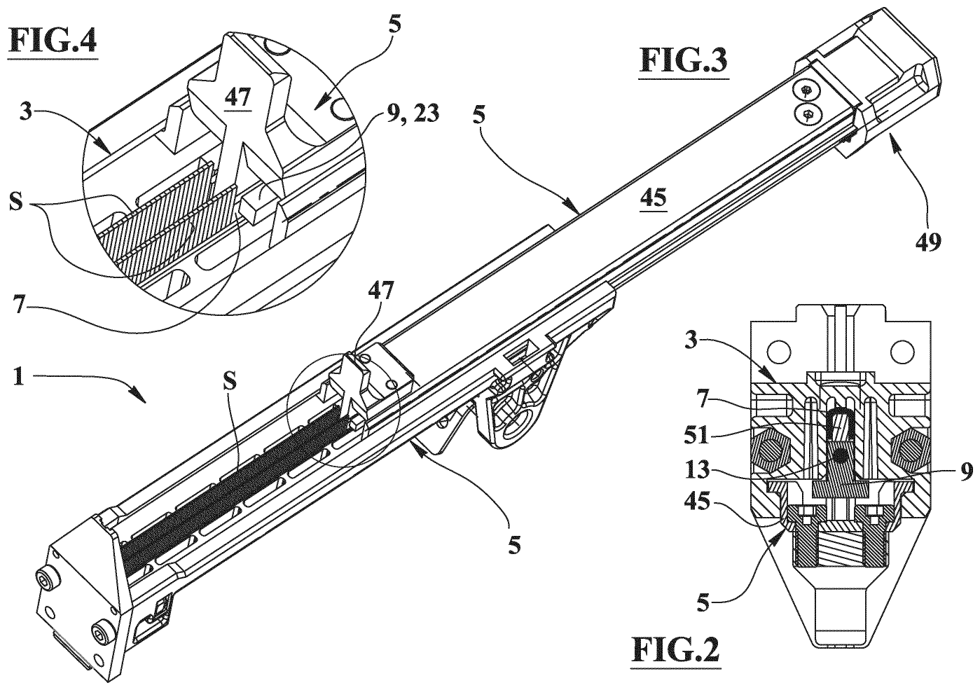

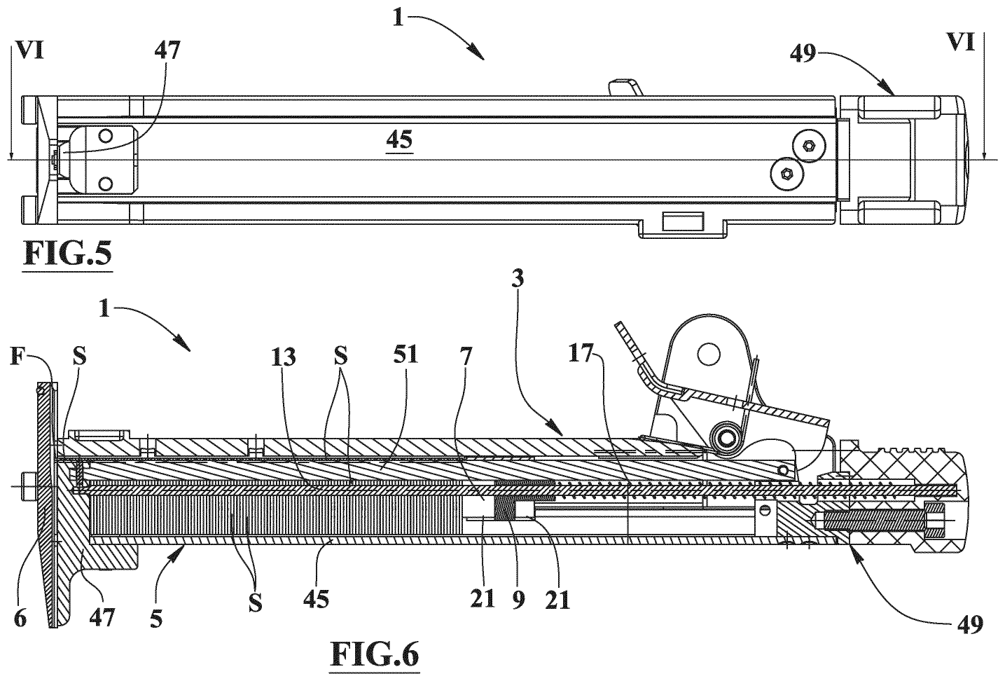

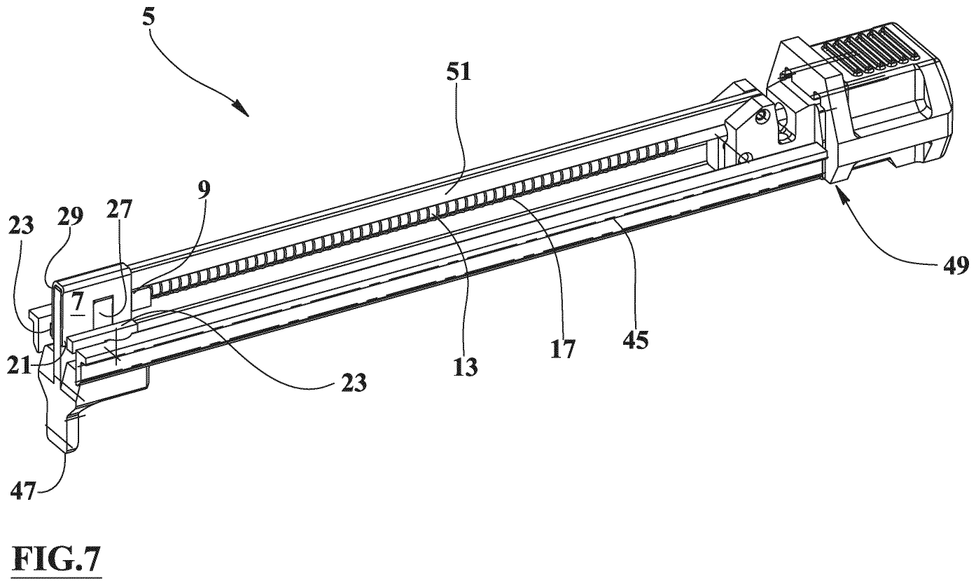

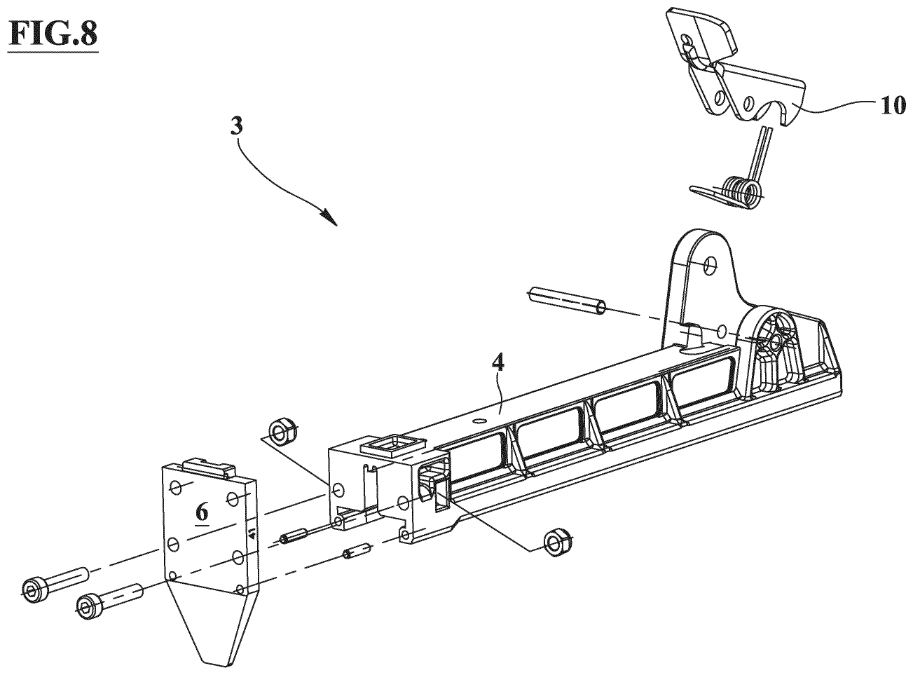

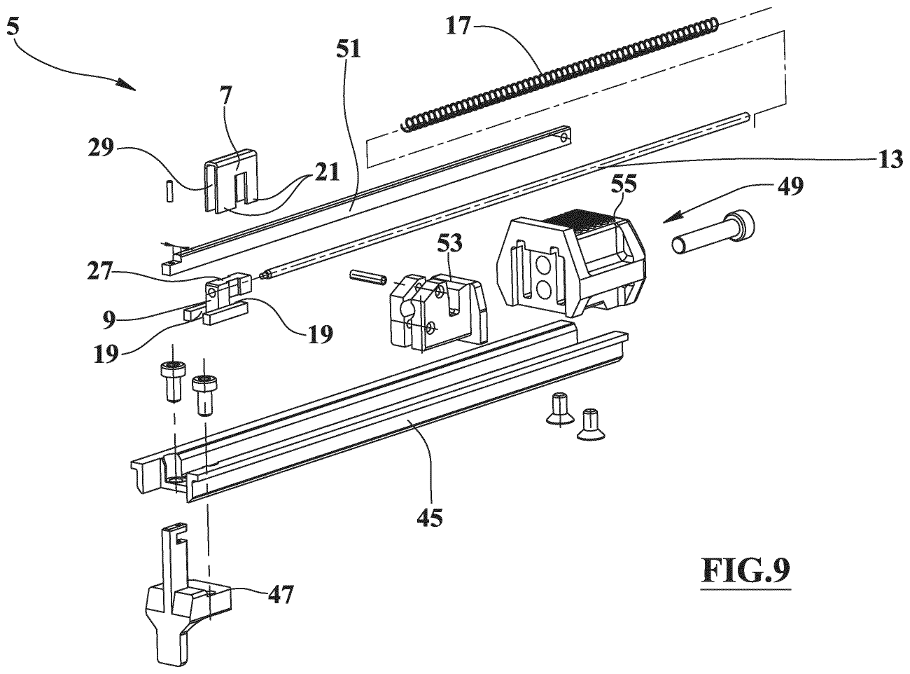

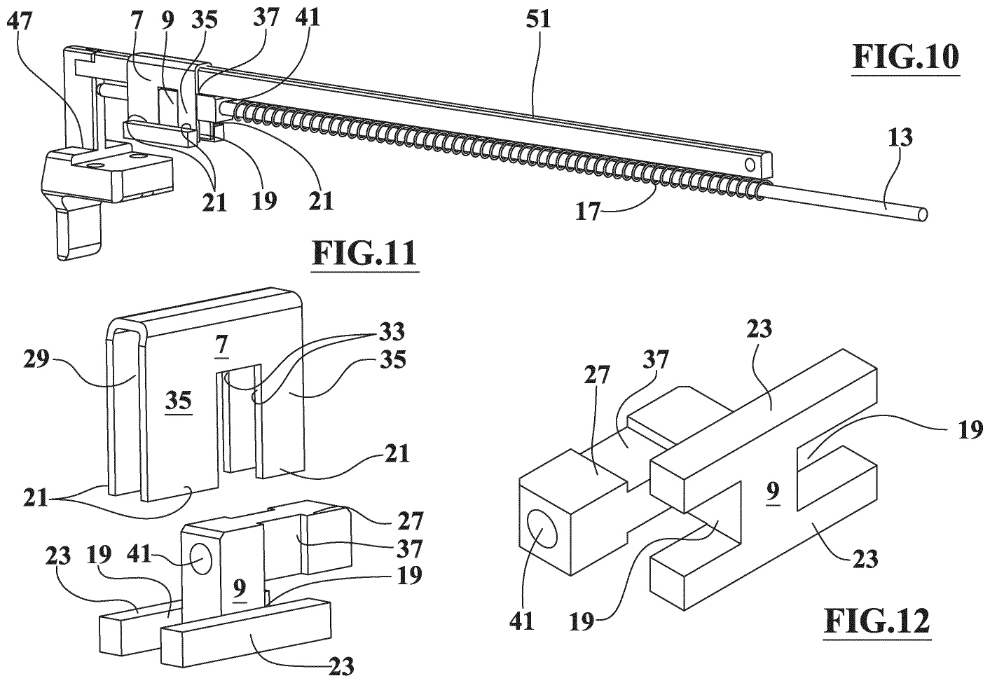

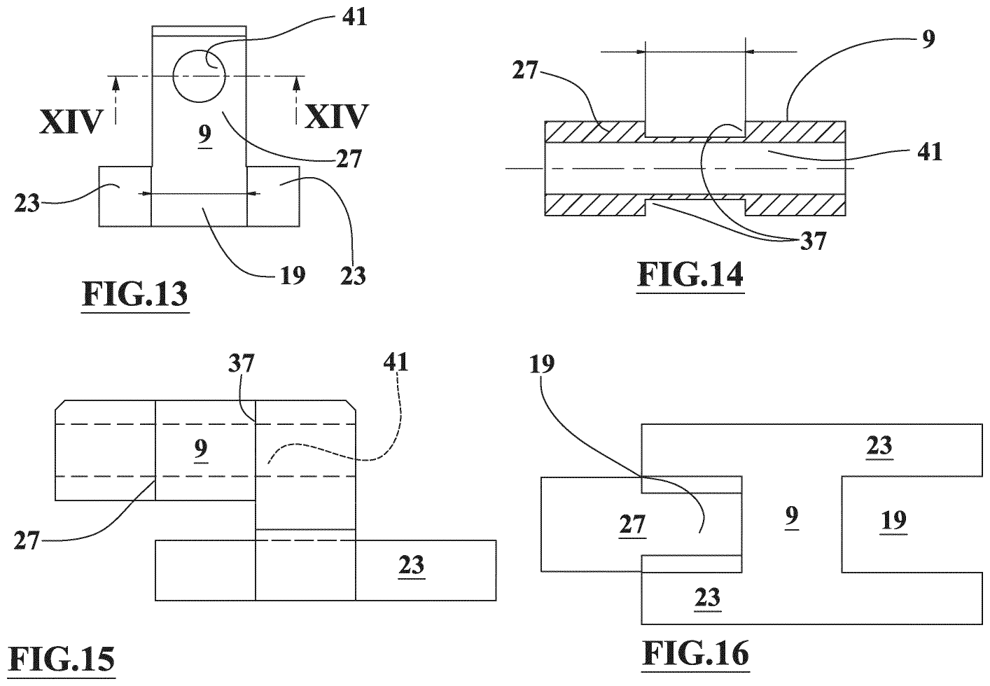

With reference to FIGS. 1-16, numeral 1 refers to a magazine of the stapler device with anti-jamming magazine of the staples S.

The device is provided with an actuator, for example electric, pyrotechnic, of another nature or preferably of a pneumatic piston type, assigned to accelerate and translate an ejection rod which, following a command given for example by means of a trigger, acts on the head of a staple fed into a strike site F of the device from the magazine 1.

The part of the device consisting of the actuator, its body, handle or attachment, trigger or valve and other parts is of a known type and is therefore not illustrated as it is not necessary for understanding the invention.

The magazine 1 comprises a container element 3 for storing and sliding the staples S towards the site F. Such container element 3 comprises a hollow body 4 with an elongated prismatic shape and at one end has a plate 6 in which a channel for the strike rod and the strike site cavity F is provided.

The magazine 1 is fixed to the body of the device by means of attachments made at the ends of the container element 3. Such container element 3 is provided with a longitudinal site for the storage and sliding of a strip of staples and two lateral and longitudinal grooves for the sliding of a cover 45 of a closure member 5 assigned for opening and closing the longitudinal site of the container element 3.

The closure member 5 of the container 3 can be reversibly blocked in its closed position by a locking hook 10 of the container which prevents the closure member and its cover 45 from sliding towards its open position.

The magazine 1 also comprises a thrusting member 7, a support 9, a first guide member 13 and resilient means 17 which, when the cover 45 of the closure member 5 is closed, are housed, at least partially, in the longitudinal site of the container element 3.

The support 9 supports the thrusting member 7, to which it is connected, and slides along the first guide member 13 elastically pushed towards the strike site by the elastic force of the resilient means 17 to elastically press the staples housed in the longitudinal site of the container element 3 and push them towards site F, obviously when the staples are present in the seat and the container 3 is closed.

The resilient means 17 can act directly on the thrusting member 7 or, preferably and as illustrated, by means of the support member 9.

The thrusting member 7 consists of an element preferably made of bent or cast metal sheet or plate, alternatively it can be made of synthetic material, for example plastic or resin, also filled with fibres or other reinforcements.

The thrusting member 7 has two side walls that are almost mutually parallel and a connection wall that is approximately perpendicular to the side walls and of which it connects two sides so that at least one cross section of such thrusting member is approximately “U” shaped. Such cross section approximately reproduces the shape and dimensions of the staples S contained in the container element 3 and to which said thrusting member 7 is assigned to transmit said elastic force directed towards the strike site.

The flaps or free edges of the lateral walls opposite the transversal wall of the thrusting member have respective opposite outer faces of free edges 21.

The support member 9 is provided with one or more concave housings 19 for said free edges of the side walls of the thrusting member 7.

Each external face of each of the flaps or free edges 21 of the side walls of the thrusting member meets with a corresponding side face or edge of the respective concave housing 19. In this way the flaps or free edges of the side walls are kept mutually parallel and at a mutual fixed distance even under stress and after a virtually infinite number of work cycles, preventing the deformation of the thrusting member 7 and in particular the widening of its side walls.

The concave housings may consist, for example, of slots or grooves made in the support member but preferably, and as illustrated, such support member 9 is provided with two side lock walls 23, cantilevered to the rest of the support member, and which delimit the interposed concave housing 19, defining its external sides arranged longitudinally.

The mutually facing faces of the two lock walls 23, which delimit the concave housing 19, meet with the external faces 21 of the flaps or free edges of the two side walls of the thrusting member, blocking them.

The two lock walls 23 develop longitudinally for a length approximately equal to or slightly less than the longitudinal length of the flaps or free edges of the side walls of the thrusting member 7.

The support member 9, preferably metallic and obtained by casting or removal, is provided with a connection portion 27 thereof assigned to be at least partially housed in a concavity 29 defined by the side and transversal walls of the thrusting member 7.

The side of the connection portion 27 opposite to that corresponding to the position of the transversal wall of the connected thrusting means carries a protrusion to the sides of which the two lock walls 23 are cantilevered fixed, as clearly visible, for example, in FIGS. 11-16.

Each side wall of the thrusting member 7 has a respective opening 33, for example of rectangular shape and open in the opposite direction to the transversal wall, which divides the side wall into two side portions 35.

One of these portions 35 is housed in a corresponding clamp site 37, hollow and complementary in shape to the side wall portion, obtained in the connection portion 27 of the support member 9.

In this way the sides or transversal edges of the portions 35 and opening 33 act as shoulders for transmitting the longitudinal elastic force to the resilient means 17 and also contribute to the correct connection of the thrusting member 7 to the support member 9.

The connection portion 27 of the support member 9 has an axial through bore 41 which accommodates the first guide member 13 in a freely sliding manner.

The cross sections of the axial bore and the first guide member are of complementary shapes, for example square, rectangular, polygonal or preferably, and as illustrated, circular.

The connection portion 27 of the support member 9 is in the shape of a parallelepiped with two opposite faces, matching the internal side faces of the concavity 29 of the thrusting member 7, carrying respective concavities, each consisting of a respective clamp site 37.

The lock walls 23, which delimit the concave housing 19, are in the shape of a parallelepiped with the main longitudinal axis parallel to that of the connection portion 27 to which they are fixed by means of said protrusion of the latter 27.

The concave housing 19 can develop into a single continuous section or comprise several distinct sections.

The geometric planes defined by said opposite faces of the connection portion 27 of the support member 9 and by the internal faces of the lock walls 23 that delimit the concave sites are placed at mutual distances equal to or slightly greater than the thickness of the side walls of the thrusting member 7 so that at least said edges of such walls can fit between the connection portion 27 of the support member 9 and the lock walls 23.

The thrusting member 7, the support 9, the first guide member 13 and the resilient means 17 can be of the removable type associated with the magazine or, preferably and as illustrated, are permanently connected to the closure member 5.

The cover 45 of the closure member 5 is flat plate shaped, elongated and parallel to the first guide member 13 and its longitudinal edges slide in said respective grooves of the container element 3 for closing and opening the latter.

One end of the cover 45 carries an end element 47 which, in the closed condition of the magazine, meets the plate 6 of the container element 3, allowing the longitudinal site of the container element 3 to flow into the strike site F.

The other end of the cover 45 carries a grabbing element 49.

The ends of the first guide member 13 are connected to respective sites obtained in the end 47 and grabbing 49 elements, the resilient means 17 are of the helical spring type containing the first guide member 13 and compressed between the grabbing element 49 and the support member 9.

The magazine 1 comprises a second guide member 51 in the shape of an elongated parallelepiped, parallel to the first 13 and with ends connected to the end 47 and grabbing 49 elements. The thrusting member 7 and the staples S, when present, are slidably engaged to the second guide member 51 too.

The thrusting member 7 embraces both the support member 9, to which it is fixed, and the second guide member 51 which slides through the portion of the concavity 29 comprised between the transversal wall, the portions of the side walls adjacent to it and the support member 9 which protrudes on one side of the second guide member 51.

As clearly visible for example in FIG. 6, the first 13 and second 51 guide members are parallel and are placed between the legs of the staples acting as a guide for them, guaranteeing their perfect positioning with any orientation of the device.

The grabbing element 49 comprises a first fastening element 53 assigned to the passage of the first guide member 13 and the resilient means 17 and to the fixing of a respective end of the second guide member 51 and comprises a second fastening element 55 connected to a respective end of the first guide member 13; the opposite ends of the first 13 and second 51 guide members are locked to the end element 47.

1) Stapler device with anti-jamming magazine of the staples(S) and provided with a strike site (F) of the staples fed by the magazine (1) comprising at least:
a container element (3) for storing and sliding the staples(S) towards the strike site (F);
a closure member (5) of the container (3) to open and close the latter;
a thrusting member (7), having two mutually parallel sidewalls and a connection wall approximately perpendicular to the sidewalls and of which it connects two sides so that at least one cross section of this thrusting member is U-shaped; said thrusting member (7) is assigned to transmit to the staples (S) contained in the container element (3) of the magazine (1) an elastic force directed towards the strike site;
said device being characterized in that it comprises a support member (9) assigned to support the thrusting member (7) and to slide along at least one first guide member (13) of the stapler device and in that it comprises resilient means (17) acting, in the direction of the strike site, on the thrusting member (7) directly or by means of the support member (9), which is provided with at least a concave housing (19) for matching with outer faces of free edges (21), opposite to the respective connecting sides of the transverse connection wall, of the side walls of the thrusting member (7) preventing deformation of the latter (7).

2) Device according to claim 1 characterized in that at least one side of each concave housing (19) is delimited by a lock wall (23) assigned to abut with one of said respective outer faces of a free edge (21) of the thrusting member (7).

3) Device according to claim 1 characterized in that the support member (9) is provided with a connection portion (27) assigned to be at least partially housed in a concavity (29) defined by the side and transversal walls of the thrusting member (7).

4) Device according to claim 3 characterized in that each side wall of the thrusting member (7) carries a respective opening (33) which separates two portions of the side wall, where at least one of these portions (35) is housed in a corresponding clamp site (37) obtained in the connection portion (27) of the support member (9).

5) Device according to claim 3 characterized in that the connection portion (27) has an axial through bore (41) which receives the first guide member (13) in a freely sliding manner; the cross sections of the axial bore and the first guide member are complementary and circular or of other shapes.

6) Device according to claim 3 characterized in that the connection portion (27) of the support member (9) are parallelepiped-shaped with two opposite faces, matching with the inner faces of the concavity (29) of the thrusting member (7), bearing respective concavities, each consisting of a respective clamp site (37); the lock walls (23), which delimit the concave housings (19), are parallelepiped-shaped with the main longitudinal axis parallel to that of the connection portion (27) to which they are fixed by means of a protrusion of the latter (27); where the geometric planes defined by said opposite faces of the connection portion (27) of the support member (9) and by the inner faces of the lock walls (23) which delimit the concave seats are placed at reciprocal distances equal to or slightly greater than the thickness of the side walls of the thrusting member (7) so that at least said edges of these walls can fit between the connection portion (27) of the support member (9) and the lock walls (23).

7) Device according to claim 1 characterized in that the closure member (5) comprises a flat plate shaped cover (45), elongated and parallel to the first guide member (13) and having longitudinal edges sliding in respective grooves of the container element (3) for closing and opening the latter, where one end of the cover (45) carries an end element (47) for closing the strike site (F) and the other end carries a grabbing element (49), where the ends of the first guide member (13) are connected to respective seats formed in the end (47) and grabbing (49) element, the resilient means (17) are of the coil spring type containing the first guide member (13) and compressed between the grabbing element (49) and the support member (9).

8) Device according to claim 7 characterized in that it comprises a second guide member (51) parallel to the first (13) and with ends connected to the end (47) and grabbing (49) elements; the thrusting member (7) and the staples(S), when present, are slidingly engaged to the second guide member (51).

9) Device according to claim 8 characterized in that the second guide member (51) has the shape of an elongated parallelepiped.

10) Device according to claim 9 characterized in that the grabbing element (49) comprises a fastening element (53) assigned for the passage of the first guide member (13) and the resilient means (17) and for fixing a respective end of the second guide member (51) and comprises a second fastening element connected to a respective end of the first guide member (13); the opposite ends of the first (13) and second (51) guide members are locked to the end element (47).
